(19) United States
(12) Patent Application Publication
(10) Pub. No.: US 2022/0029238 A1
(43) Pub. Date: Jan. 27, 2022

(54) Battery Module with Double Fixing Structure and Manufacturing Method Thereof

(71) Applicant: SK Innovation Co., Ltd., Seoul (KR)

(72) Inventor: Ji Hoon Lim, Daejeon (KR)

(21) Appl. No.: 17/381,306

(22) Filed: Jul. 21, 2021

(30) Foreign Application Priority Data
Jul. 24, 2020 (KR) 10-2020-0092530

(51) Int. Cl. H01M 50/264; H01M 50/209; H01M 50/271; H01M 50/258

(52) U.S. Cl. CPC H01M 50/264; H01M 50/258; H01M 50/271; H01M 50/209

(57) ABSTRACT

Provided are a battery module having a double fixing structure and a manufacturing method thereof having a high coupling strength between members by fitting a recess portion formed at an end portion of a module housing accommodating the battery cells and an insertion portion formed at an end portion of a part for coupling of the battery module such as an upper cover coupled to a module housing to each other by end portions of the battery module, the upper cover, and a case part that accommodate a plurality of secondary battery cells formed in a double fixing structure, and applying a bond to the inside of the recess portion and fixing each part of the battery module through welding to the outside of the battery module.

### CROSS-REFERENCE TO RELATED APPLICATION

This application claims priority to Korean Patent Application No. 10-2020-0092530 filed Jul. 24, 2020, the disclosure of which is hereby incorporated by reference in its entirety.

### BACKGROUND OF THE INVENTION

### Field of the Invention

The following disclosure relates to a battery module and a manufacturing method thereof, and more particularly, to a battery module including a structure having high coupling strength during welding and a manufacturing method thereof.

### Description of Related Art

A secondary battery cell is formed in a form in which an electrode assembly including a cathode, an anode, a separator, and an electrolyte is surrounded with an exterior material. A single secondary battery cell is suitable for driving small electronic devices, but there is a limit in energy capacity to provide a current required to drive medium and large-sized electronic devices such as electric vehicles and home appliances. Therefore, a battery module accommodating a plurality of battery cells in one place or a battery pack accommodating a plurality of battery modules is used for the medium and large-sized electronic devices.

In general, as illustrated in FIG. 1, the battery module includes a plurality of battery cells 1, a module housing 2, and an upper cover 3, and further includes a front cover 4 and a rear cover 5 according to the characteristics and design of the electronic device used. Here, the module housing 2 accommodates the plurality of battery cells 1, the module housing 2, the upper cover 3, the front cover 4, and the rear cover 5 are assembled in a form that surrounds the plurality of battery cells 1, and thereafter, the module housing 2 is weld-bonded to the upper cover 3, the front cover 4, and the rear cover 5 by laser welding or the like so as to be coupled to the upper cover 3, the front cover 4, and the rear cover 5.

However, when each part of the battery module is bonded by welding, defects may occur depending on the surrounding environment and welding conditions, and when a member such as a cooling hole is formed in the battery module, there is a problem in that welding strength is lowered around the member. In addition, since equipment such as CT, X-ray, and ultrasonic detection is used to accurately determine welding quality in a mass production line, the number of inspection equipment, inspection time, inspection cost, and the like may increase.

### SUMMARY OF THE INVENTION

An embodiment of the present invention is to provide a structure capable of improving a coupling force between components constituting an exterior of a battery module during welding, thereby reducing defects occurring in a welding process, reducing costs by reducing inspection equipment, and increasing stability during the user of the battery module with the coupling force provided by a double fixing structure.

In one general aspect, a battery module having a double fixing structure, includes: a plurality of battery cells formed to include a cathode, an anode, a separator, and an electrolyte; a module housing in which a space for accommodating the plurality of battery cells is formed; an upper cover disposed on an upper portion of the module housing and coupled to both end portions of the module housing; a front cover disposed on a front surface of the module housing; and a rear cover disposed on a rear surface of the module housing, wherein the end portion of the module housing is formed with a recess portion for accommodating an end portion of at least one of the upper cover, the front cover, and the rear cover, and the end portion of at least one of the upper cover, the front cover and the rear cover is formed with an insertion portion inserted into the recess portion, so that the recess portion and the insertion portion are fitted to each other.

The recess portion may include a first protruding portion that protrudes upwardly and is disposed outside the module housing, a second protruding portion that protrudes upwardly and is disposed inside the module housing, and a bottom portion that connects lower sides of the first protruding portion and the second protruding portion.

The recess portion may be formed so that a height of the first protruding portion is higher than a height of the second protruding portion.

The insertion portion may include a mount unit that is in surface-contact with an upper surface of the first protruding portion; and an insertion protrusion portion inserted between the first protruding portion and the second protruding portion, the insertion protrusion portion being in surface-contact with at least one of the first protruding portion, the second protruding portion, and the bottom portion.

A position where the first protruding portion and the mount portion are in surface-contact may be coupled by welding, and an adhesive may be applied to the recess portion, so that the coupling of the bottom portion and the insertion protrusion portion is a bond coupling.

The insertion portion may include an insertion protrusion portion inserted between the first protruding portion and the second protruding portion, and a mount portion opposite to the first protruding portion, and a length of the insertion protrusion portion may be formed to be shorter than a length of the first protruding portion.

The insertion portion may be an insertion protrusion portion inserted between the first protruding portion and the second protruding portion to be in surface-contact with the bottom portion, and an end portion of the insertion protrusion portion may be formed in an inclined shape.

The end portion of the insertion protrusion portion may be formed in an inclined shape inclined to the outside of the module housing or an inclined shape inclined to both sides of the module housing.

In another general aspect, a manufacturing method of a battery module having a double fixing structure includes: a battery accommodating step of accommodating a plurality of battery cells in a module housing; an adhesive applying step of applying an adhesive to a recess portion formed at an end portion of the module housing; a module assembling step of assembling the recess portion formed at the end portion of the module housing and an insertion portion formed at an end portion of at least one of an upper cover, a front cover, and a rear cover so as to be in contact with each other; and a module welding step of welding the outside of the module housing in contact with the recess portion and the insertion portion.

### BRIEF DESCRIPTION OF THE DRAWINGS

FIG. 1 is a view illustrating a configuration of a general battery module.

FIG. 2 is a view illustrating a battery module having a double fixing structure according to the present invention.

FIG. 3 is an enlarged cross-sectional view illustrating a recess portion according to the present invention.

FIG. 4 is an enlarged cross-sectional view illustrating an insertion portion according to the present invention.

FIGS. 5A to 5C are conceptual views illustrating an assembling step of the battery module according to the present invention.

FIG. 6 is a conceptual view illustrating a coupling relationship between a module housing and an upper cover.

FIGS. 7A and 7B are views illustrating modified examples of the coupling relationship between the module housing and the upper cover.

FIG. 8 is a flowchart illustrating a manufacturing method of a battery module according to the present invention.

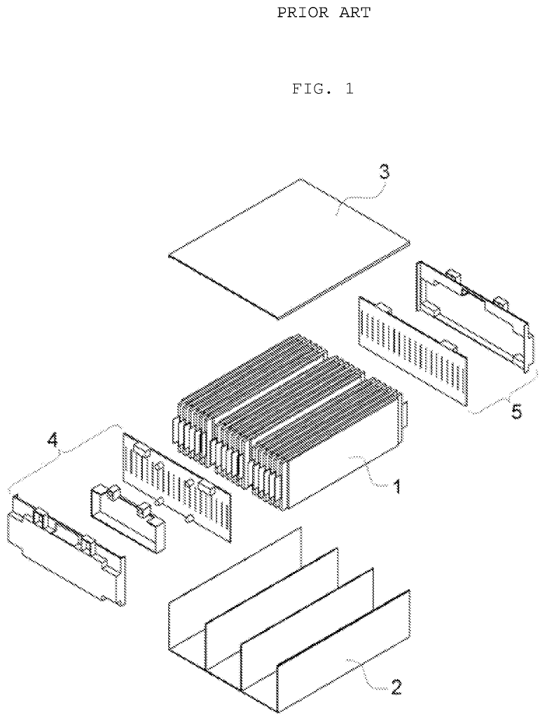

### DESCRIPTION OF THE INVENTION

Hereinafter, a technical spirit of the present invention will be described in more detail with reference to the accompanying drawings.

The accompanying drawings are only examples shown to describe the technical spirit of the present invention in more detail, and therefore, the technical spirit of the present invention is not limited to the form of the accompanying drawings. Since the present invention may be variously modified and have several embodiments, specific embodiments will be shown in the accompanying drawings and be described in detail. However, it is to be understood that the present invention is not limited to a specific embodiment, but includes all modifications, equivalents, and substitutions without departing from the scope and spirit of the present invention.

It is to be understood that when one component is referred to as being “connected to” or “coupled to” another component, it may be connected directly to or coupled directly to another component or be connected to or coupled to another component while having the other component interposed therebetween.

Unless otherwise defined, all terms, including technical or scientific terms, used herein have the same meaning as commonly understood by one of ordinary skill in the art to which the present invention belongs. It should be interpreted that terms defined by a generally used dictionary are identical with the meanings within the context of the related art, and they should not be ideally or excessively formally interpreted unless the context clearly dictates otherwise.

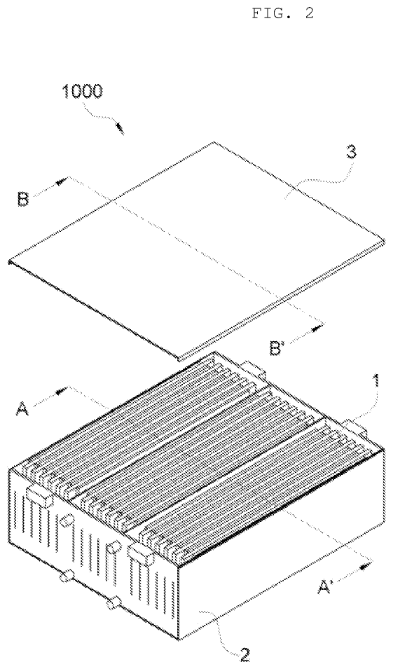

FIG. 2 is a perspective view of a battery module using a double fixing structure according to the present invention. Referring to FIG. 2, in a battery module 1000 having a double fixing structure according to the present invention, after a plurality of battery cells 1 are accommodated in a module housing 2, a front cover 4 and a rear cover 5 for protecting the plurality of battery cells 1 are coupled to the module housing 2, and an upper cover 3 is then assembled. At this time, the battery module 1000 having the double fixing structure according to the present invention includes a recess portion 100 and an insertion portion 200.

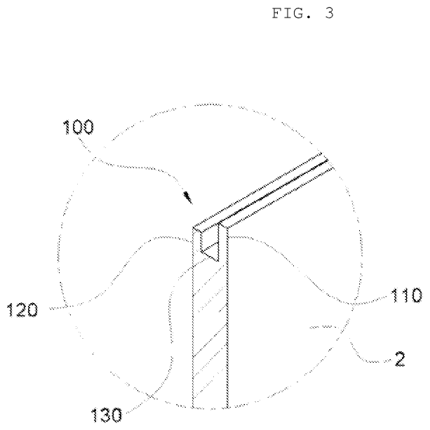

The recess portion 100 is formed in a shape in which an end portion of each corner of the module housing 2 coupled to the upper cover 3, the front cover 4 and the rear cover 5 is partially recessed to serve to surround the insertion portion formed at end corners of the upper cover 3, the front cover 4, and the rear cover 5 on three surfaces. Therefore, by applying an adhesive such as a bond to a space where the recess portion 100 surrounds the end edges of the upper cover 3, the front cover 4, and the rear cover 5 on the three surfaces, the recess portion 100 serves to temporarily fix the components to be assembled to the module housing 2 during the assembly of the battery module and provides an additional coupling force to the battery module after welding. A detailed shape of the recess portion 100 will be described later with reference to FIG. 3.

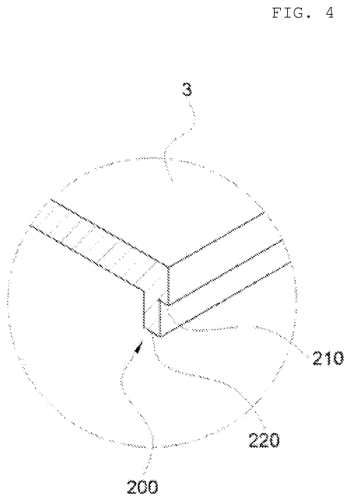

The insertion portion 200 is coupled with the recess portion 100 in a shape in which a portion of the end portions of the upper cover 3, the front cover 4 and the rear cover 5 protrudes, such that both side surfaces and a lower surface of the protruding portion of the insertion portion 200, that is, three surfaces, are sealed by the recess portion 100. Therefore, in the assembly process of the battery module, the insertion portion 200 is inserted into the recess portion 100 into which the adhesive is applied and is temporarily fixed, and a boundary formed by the insertion portion 200 and the recess portion 100 is welded from the outside of the battery module to provide a coupling force between the components of the battery module. A detailed shape of the insertion portion 200 will be described later with reference to FIG. 4.

FIG. 3 illustrates an enlarged cross-sectional view of the recess portion according to the present invention. As illustrated in FIG. 3, the battery module 1000 having the double fixing structure according to the present invention has the recess portion 100 formed at an end portion of the module housing 2. The portion illustrated in FIG. 3 is an enlarged portion of the recess portion 100 formed in the module housing 2 of a cross-section taken along line A-A′ illustrated in FIG. 2. The recess portion 100 includes a first protruding portion 110, a second protruding portion 120, and a bottom portion 130, and each portion will be described as follows.

The first protruding portion 110, which protrudes upward from the end portion of the module housing 2 and is disposed outside the module housing 2, serves to be in contact with the insertion portion 200. At this time, a welding process is performed at a position of the first protruding portion 110 in contact with the insertion portion 200.

The second protruding portion 120, which protrudes upward from the end portion of the module housing 2 and is disposed inside the module housing 2, serves to form a space into which the insertion portion 200 is inserted, together with the first protruding portion. Additionally, the second protruding portion 120 may extend to a position in contact with an inner upper surface of the insertion portion 200.

The bottom portion 130 serves to connect lower side surfaces of the first protruding portion 110 and the second protruding portion 120. Therefore, a space is formed between the first protruding portion 110 and the second protruding portion 120 so that a protruding shape of the insertion portion 200 is inserted thereinto, and after applying a bond to the bottom portion 130 before assembling the battery module, the part of the battery module such as the upper cover 3 is assembled. Thereafter, it is possible to significantly reduce defects in the welding portion caused by vibration or the like when performing a welding process that provides additional coupling strength of the battery module.

FIG. 4 illustrates an enlarged cross-sectional view of the insertion portion according to the present invention. As illustrated in FIG. 4, the battery module 1000 having the double fixing structure according to the present invention has the insertion portion 200 formed at an end portion of each of the upper cover 3, the front cover 4, and the rear cover 5, which are the part coupled to the module housing 2. The portion illustrated in FIG. 4 is an enlarged portion of the insertion portion 200 formed on the upper cover 3 of a cross-section taken along line B-B′ illustrated in FIG. 3. The insertion portion 200 includes a mount portion 210 and an insertion protrusion portion 220. Each portion will be described in detail as follows.

The mount portion 210 is formed inwardly with a step at an edge end of the upper cover 3, and is formed so as to be in surface contact with the upper surface and the inner side surface of the first protruding portion 110 illustrated in FIG. 3. The insertion protrusion portion 220 is inserted into the space formed by the recess portion 100, that is, the first protruding portion 110 and the second protruding portion 120, and may be in surface contact with the first protruding portion 110, the second protruding portion 120, and the bottom portion 130 on three surfaces. Therefore, when a bond is applied to the bottom portion 130 before the insertion protrusion portion 220 is inserted, the insertion protrusion portion 220 may be inserted into the recess portion 100 and fixed, and bonding is performed at a predetermined distance from the welding portion. As a result, the bonding is not affected by welding.

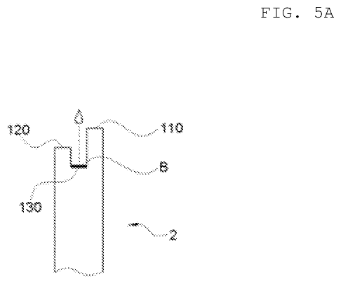

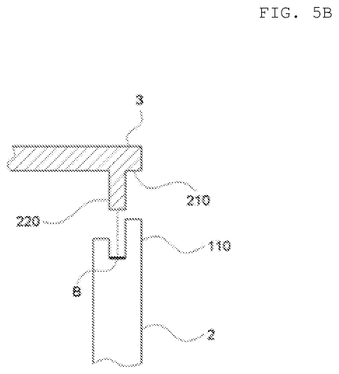

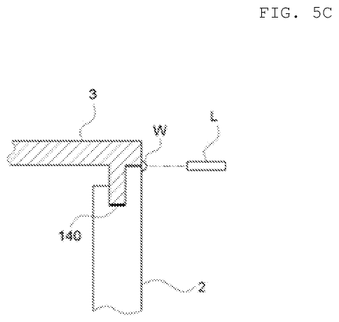

FIGS. 5A to 5C are conceptual views illustrating an assembling step of the battery module according to the present invention. First, as illustrated in FIG. 5A, an adhesive such as a bond B is applied on the recess portion 100 formed in the module housing 2. At this time, the bond B is applied on the bottom portion 130 inside the space formed by the first protruding portion 110 and the second protruding portion 120, and the amount of the applied bond is preferably applied so that the bottom portion 130 and the insertion portion 200 are in contact. In addition, the amount of the bond B may be additionally adjusted so that the bond B flows to the lower partial regions of the first protruding portion 110 and the second protruding portion 120 by pressure of the inserted insertion portion 200. In addition, the module housing 2 illustrated in FIG. 5A may be a state in which a plurality of battery cells are accommodated, or the bond B may be applied along with the accommodation.

Thereafter, as illustrated in FIG. 5B, the insertion portion 200 formed in the assembly members of the battery module covering the open region of the module housing 2 such as the upper cover 3 is aligned with the recess portion 100. Thereafter, the battery module is assembled by inserting the insertion portion 200 into the recess portion 100, and is primarily fixed by the bond applied to the recess portion 100.

Finally, as illustrated in FIG. 5C, in the state where the upper cover and the like are primarily fixed to the module housing 2 by the bond B, a portion where the insertion portion 200 and the recess portion 100 are in contact with each other is welded from the outside of the battery module through welding equipment such as a laser module L. Accordingly, a welding portion W is formed on the outside of the battery module. In addition, an additional polishing process may also be performed for processing uniformity and precision of the welding portion W.

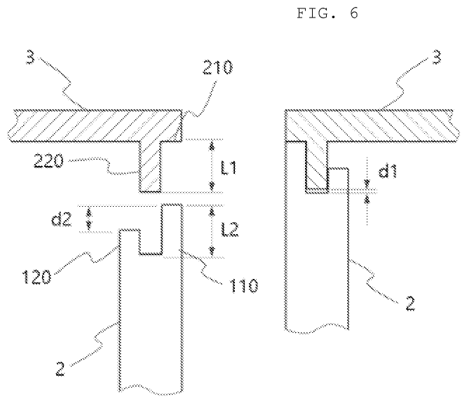

FIG. 6 is a conceptual view illustrating a coupling relationship between the module housing 2 and the upper cover 3 according to the present invention. Referring to FIG. 6, when a protruding length of the insertion protrusion portion 220 of the upper cover 3 is defined as L1, and a protruding length of the first protruding portion 110 of the module housing 2 opposite to the mount portion 210 of the upper cover 3 is defined as L2, it is preferable that L1 is formed to be shorter than L2. When the protruding length of the insertion protrusion portion 220 is formed to be shorter than the protruding length of the first protruding portion 110 as described above, a gap d1 may be formed between the end portion of the insertion protrusion portion 220 of the upper cover 3 and the recess portion 100 when the upper cover 3 is coupled to the module housing 2, a sufficient amount of adhesive may be applied to the gap d1 formed between the end portion of the insertion protrusion portion 220 and the recess portion 100, and the upper cover 3 and the module housing 2 may be more strongly coupled due to the sufficiently applied adhesive.

On the other hand, in consideration of a thickness of the adhesive applied between the end portion of the insertion protrusion portion 220 of the upper cover 3 and the bottom portion 130 of the recess portion 100, the above-described protruding lengths may be adjusted so that the gap is not formed between the end portion of the first protruding portion 110 and the mount portion 210 of the upper cover 3. For example, by forming the protruding length L1 of the insertion protrusion portion 220 to be shorter than the protruding length L2 of the first protruding portion 110 of the module housing 2 when the amount of adhesive applied is large, it is possible to prevent the gap from being formed between the end portion of the first protruding portion 110 of the module housing 2 and the mount portion 210 of the upper cover 3 due to the thickness of the applied adhesive.

In addition, the length of the first protruding portion 110 of the module housing 2 is formed to be longer than a length of the second protruding portion 120, so that a predetermined distance d2 is preferably formed between the first protruding portion 110 and the second protruding portion 120. As a result, when the upper cover 3 is assembled, the insertion protrusion portion 220 of the upper cover 3 may be guided by the second protruding portion 120 and may be easily guided to the recess portion 100.

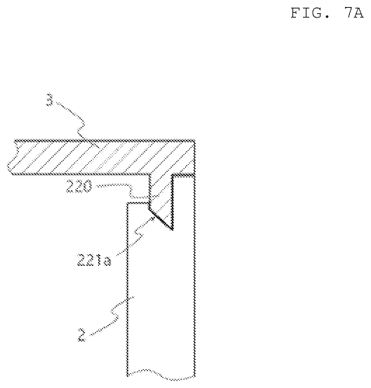

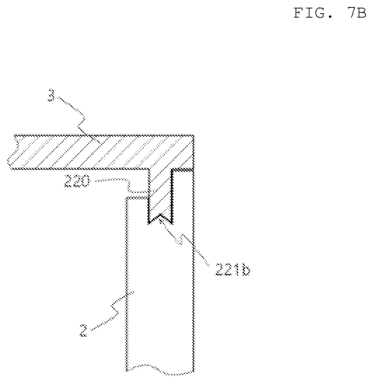

FIGS. 7A and 7B illustrate modified examples of the coupling relationship between the module housing 2 and the upper cover 3. Referring to FIGS. 7A and 7B, the end portion of the insertion protrusion portion 220 of the upper cover 3 may be formed in an inclined shape. As an example, the end portion of the insertion protrusion portion 220 of the upper cover 3 may have a shape 221a inclined to one side as illustrated in FIG. 7A or a shape 221b inclined to both sides as illustrated in FIG. 7B. When the end portion of the insertion protrusion portion 220 of the upper cover 3 has the shape 221a inclined to one side, it is possible to prevent slip during welding by making the length of a side in a direction of the welding portion longer, and thus more stable welding is possible. Alternatively, a twist may be prevented, so that stable welding is possible. In addition, as the end portion of the insertion protrusion portion 220 is formed in the inclined shape, an adhesive surface may be widened to increase an adhesive effect, and it is possible to prevent the upper cover 3 from slipping or being twisted during welding.

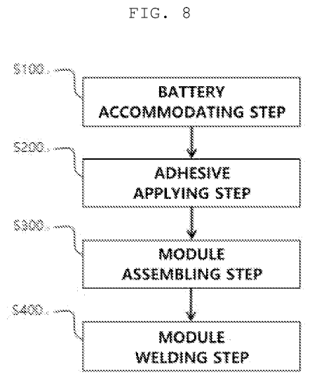

FIG. 8 is a flowchart illustrating a manufacturing method of a battery module according to the present invention. Referring to FIG. 8, a method of manufacturing the battery module 1000 having the double fixing structure according to the present invention includes a battery accommodating step (S100), an adhesive applying step (S200), a module assembling step (S300), and a module welding step (S400).

In the battery accommodating step (S100), a plurality of battery cells 1 are accommodated in the module housing 2.

Thereafter, in the adhesive applying step (S200), an adhesive such as a bond B is applied to the end portion of the module housing 2, that is, the recess portion 100, and a user sets and applies an appropriate amount of adhesive such as the bond B on the bottom portion connecting between the first protruding portion 110 and the second protruding portion 120.

Thereafter, in the module assembling step (S300), the insertion portion 200 formed on the upper cover 3, the front cover 4, and the rear cover 5, and the like is inserted into the recess portion 100 of the module housing 2 to which the adhesive is applied in the adhesive applying step (S200) and is primarily fixed.

Finally, in the module welding step (S400), an outside portion of the battery module in which the recess portion 100 and the insertion portion 200 fixed by the adhesive in the module assembling step (S300) are in contact, that is, the welding portion, is welded with welding equipment, and is secondarily fixed. In this case, the welding in the module welding step (S400) may include laser welding. Additionally, the manufacturing method may also include an additional welding or polishing process for the welding portion for a quality of the welding porting after the module welding step (S400).

As described above, the battery module according to the present invention may increase the coupling strength between the components during welding, and may reduce the inspection process performed for the welding quality of the battery module in the production line, thereby reducing production time and cost.

The present invention is not limited to the above-mentioned embodiments, and may be variously applied, and may be variously modified without departing from the gist of the present invention claimed in the claims.

[Detailed Description of Main Elements]
1000: battery module
100: recess portion
110: first protruding portion
120: second protruding portion
130: bottom portion
200: insertion portion
210: mount portion
220: insertion protrusion portion
1: a plurality of battery cells
2: module housing
3: upper cover
4: front cover
5: rear cover
B: adhesive
W: welding portion

What is claimed is:

1. A battery module having a double fixing structure, the battery module comprising:
a plurality of battery cells formed to include a cathode, an anode, a separator, and an electrolyte;
a module housing in which a space for accommodating the plurality of battery cells is formed;
an upper cover disposed on an upper portion of the module housing and coupled to both end portions of the module housing;
a front cover disposed on a front surface of the module housing; and
a rear cover disposed on a rear surface of the module housing,
wherein the end portion of the module housing is formed with a recess portion for accommodating an end portion of at least one of the upper cover, the front cover, and the rear cover, and
wherein the end portion of at least one of the upper cover, the front cover and the rear cover is formed with an insertion portion inserted into the recess portion, so that the recess portion and the insertion portion are fitted to each other.

2. The battery module of claim 1, wherein the recess portion includes:
a first protruding portion that protrudes upwardly and is disposed outside the module housing,
a second protruding portion that protrudes upwardly and is disposed inside the module housing, and
a bottom portion that connects lower sides of the first protruding portion and the second protruding portion.

3. The battery module of claim 2, wherein the recess portion is formed so that a height of the first protruding portion is higher than a height of the second protruding portion.

4. The battery module of claim 2, wherein the insertion portion includes:
a mount unit that is in surface-contact with an upper surface of the first protruding portion; and
an insertion protrusion portion inserted between the first protruding portion and the second protruding portion, the insertion protrusion portion being in surface-contact with at least one of the first protruding portion, the second protruding portion, and the bottom portion.

5. The battery module of claim 4, wherein a position where the first protruding portion and the mount portion are in surface-contact is coupled by welding, and
an adhesive is applied to the recess portion, so that the coupling of the bottom portion and the insertion protrusion portion is a bond coupling.

6. The battery module of claim 2, wherein the insertion portion includes:
an insertion protrusion portion inserted between the first protruding portion and the second protruding portion, and
a mount portion opposite to the first protruding portion, and
a length of the insertion protrusion portion is formed to be shorter than a length of the first protruding portion.

7. The battery module of claim 2, wherein the insertion portion includes an insertion protrusion portion inserted between the first protruding portion and the second protruding portion to be in surface-contact with the bottom portion, and
an end portion of the insertion protrusion portion is formed in an inclined shape.

8. The battery module of claim 7, wherein the end portion of the insertion protrusion portion is formed in an inclined shape inclined to the outside of the module housing or an inclined shape inclined to both sides of the module housing.

9. A manufacturing method of a battery module having a double fixing structure of claim 1, the manufacturing method comprising:
a battery accommodating operation of accommodating a plurality of battery cells in a module housing;
an adhesive applying operation of applying an adhesive to a recess portion formed at an end portion of the module housing;
a module assembling operation of assembling the recess portion formed at the end portion of the module housing and an insertion portion formed at an end portion of at least one of an upper cover, a front cover, and a rear cover so as to be in contact with each other; and
a module welding operation of welding the outside of the module housing in contact with the recess portion and the insertion portion.
